(19) United States
(12) Patent Application Publication
(10) Pub. No.: US 2015/0316092 A1
(43) Pub. Date: Nov. 5, 2015

(54) ASSEMBLED CRANKSHAFT AND METHOD FOR PRODUCING AN ASSEMBLED CRANKSHAFT

(71) Applicant: THYSSENKRUPP PRESTA TECCENTER AG, Eschen (LI)

(72) Inventor: Alex MEIER, Triesen (LI)

(21) Appl. No.: 14/443,879

(22) PCT Filed: Nov. 14, 2013
(86) PCT No.: PCT/EP2013/073856

§ 371 Date: May 19, 2015

(30) Foreign Application Priority Data
Nov. 19, 2012 (DE) 10 2012 111 124.3

(51) Int. Cl. F16C 3/10

(52) U.S. Cl. CPC F16C 3/10

(57) ABSTRACT

The invention relates to a method for producing an assembled crankshaft for an internal combustion engine, wherein crank webs having receiving openings and crank pins fastening sections at the ends thereof are provided as join partners, wherein the receiving openings or the fastening sections are provided with teeth running in a longitudinal direction (x) of the crankshaft and wherein the cross section of the fastening sections protrudes beyond the inner cross section of the associated receiving opening in certain sections on account of the teeth, so that when the join partners are connected at the receiving openings of the crank webs or the fastening sections of the crank pins, a material displacement and contour deformation occurs and the join partners are thus connected in a form-fitting manner. According to the invention, the fastening sections are fitted into the receiving opening in such a way that the join partners are fixed to each other in an operationally safe and force fitting manner without further fastening means and without an additional connection in the longitudinal direction (x).

### FIELD

The present disclosure relates to a method for producing an assembled crankshaft for an internal combustion engine.

### BACKGROUND

A crankshaft of an internal combustion engine, due to its cranked form with eccentric arrangement of the crank pins, allows the conversion of a reciprocating motion of the pistons, connected to the crankshaft via connecting rods, into a rotary motion. Since the crankshaft of an internal combustion engine is a central element of the force transmission, very high torque and bending moments occur and also forces which vary greatly both temporally and locally. The crankshaft must therefore have adequate stability and strength.

In the crankshafts known from the prior art, the material choice and production method depend on the load. Highly loaded crankshafts are usually forged, wherein for smaller engines, cast crankshafts are used for cost and weight reasons (Bosch, Automotive Handbook, 26th Edition, 2007, page 477.ff).

To make the crankshaft more versatile, simpler and hence cheaper, the prior art also proposes assembled crankshafts which are composed of crank webs and crank pins arranged between the crank webs. This firstly gives the advantage that there is no need to produce a complete cohesive crankshaft, but smaller elements need to be produced for which correspondingly smaller forging or casting molds can also be used. Furthermore, a versatile assembly is possible due to the modular structure.

An assembled crankshaft is known from DE 822 036. At their ends, the crank bolts have teeth which are knocked into assigned openings on the crank webs, wherein the toothing cuts into the assigned receiver opening. The cutting of the toothing achieves a form-fit connection, wherein the crank pins are fixed to the crank webs by bolts. The main advantage here is that the finished crankshaft can be taken apart again at any desired point. On later re-assembly, it must be ensured that each tooth coincides with the notch it has previously produced, in order to guarantee smooth running.

The constructional design of the assembled crankshaft known from DE 822 036 is relatively complex, since the toothing of the fixing portions, an adjacent cylindrical portion of the crank pins and the fixing bolts with washers each with different dimensions, must be received inside the receiver openings. To this end, the receiver openings have a cross section which changes in steps, wherein the region in which a form fit is achieved is relatively short. The fitting of the fixing bolts is complicated. The mechanical load-bearing capacity of the known crankshaft is limited.

DE 100 38 857 A1 and DE 891 641 disclose assembled crankshafts for internal combustion engines which comprise crank webs with receiver openings and crank pins with fixing portions at their ends. A form- and force-fit connection is achieved in that the receiver openings and fixing portions have a complementary form, deviating from a circle, wherein the crank webs are shrunk onto the crank pins. According to DE 100 38 857 A1, it is furthermore proposed that the crank pins have a center portion and connecting portions arranged eccentrically thereto, so that on connection to the crank web, the lift height can be varied by the arrangement of the crank pins. With the shrink-on process described in both publications, the disadvantage arises that the material choice is limited, wherein also the process is complex.

GB 747 742 discloses a crankshaft which is made of at least two pieces and suitable for disassembly. The capacity for disassembly means that the crankshaft can easily be mounted and removed again. To allow the described production of the separate parts, pins are provided which are pressed into an assigned crank web or produced together with the corresponding crank web. These pins then simply engage in the opening of a further crank web so that separation and connection can take place easily there. The disadvantage results that this loose connection constitutes a weak point. The crankshaft described in GB 747 742 is proposed in particular for small engines of models or similar.

DE 1 270 893 discloses an assembled crankshaft which is produced according to the method described initially. The crank webs and the crank pins are pressed together. A particularly good, inseparable press connection results if grooves which may have different groove depths are provided in the longitudinal direction.

DE 40 18 542 A1 discloses an assembled crankshaft in which separate crank webs and crank pins are joined together in an interference fit. The production of the interference fit is not described further. The receiver openings of the crank webs first taper and then widen out again.

CH 567 194 A discloses a crankshaft of a piston internal combustion engine which is composed of U-shaped crank parts, each of which contain a crank pin with two crank webs and are connected by bearing parts, wherein the bearing parts each have a bearing journal and a fixing peg which is attached to the interference fit in a bore of the adjacent crank webs. The fixing peg of the bearing part is offset with its axis relative to the axis of the bearing journal, so that it is remote from the crank pin in its assigned crank web within the crank plane.

DE 29 25 058 A1 describes in general a connection between two metal parts with the aid of a form fit with a toothing and material displacement.

DE 559 779 A discloses a shrink connection between a bolt and a part having a bore, wherein longitudinal furrows are machined into a cylindrical seating face of the bolt.

### SUMMARY

A method for producing an assembled crankshaft for an internal combustion engine is provided crank webs with receiver openings and crank pins with fixing portions at their ends are provided as joint partners. The receiver openings or the fixing portions are provided with a toothing running in a longitudinal direction of the crankshaft, wherein the cross section of the fixing portions extends in regions through the toothing beyond the inner cross section of an assigned receiver opening, so that on connection of the joint partners, a material displacement and contour deformation occur at the receiver openings of the crank webs or at the fixing portions of the crank pins, and the joint partners are thus connected by form fit. The fixing portions are pressed into the receiver openings such that the joint partners are fixed together operationally reliably in a force fit connection without further fixing means and without an additional connection in the longitudinal direction.

### BRIEF DESCRIPTION OF THE DRAWINGS

The invention is described in more detail below with reference to just one exemplary embodiment shown in the drawing. The drawing shows:

FIG. 1 illustrates a crank web with two receiver openings for receiving a fixing portion of a crank pin, wherein a crank pin is already pressed in,

FIG. 2 illustrates a part view of a crank pin with an end fixing portion,

FIG. 3 illustrates a detailed view of a receiver opening in a longitudinal section before forming a toothing,

FIG. 4 illustrates a detailed view of a receiver opening in the longitudinal section after forming the toothing,

FIG. 5 illustrates a view of a complete crank web in longitudinal section,

FIG. 6 illustrates a detailed view of the toothing of the receiver opening in cross section,

FIG. 7 illustrates a side view of a crank web with two crank pins arranged thereon,

FIG. 8 illustrates the arrangement according to FIG. 7 in longitudinal section,

FIG. 9 illustrates an alternative embodiment of a crank web,

FIG. 10 illustrates an alternative embodiment of a crank pin,

FIG. 11 illustrates the crank web according to FIG. 9 and the crank pin according to FIG. 10 in connected state.

### DETAILED DESCRIPTION

In this context, the object of the invention is to develop a method for producing an assembled crankshaft, with which a crankshaft which resists high loads can be produced in a simple manner. In particular, the assembled crankshaft should be formed such that the risk of material defects or material damage in its production is reduced.

Starting from a method with the features described initially, the object is achieved according to the invention with the characteristic features of claim 1.

According to the invention, a force- and form-fit connection is achieved particularly simply without requiring further fixing means, welding or similar. Torques are reliably transmitted by the toothing running in the longitudinal direction of the crankshaft. In addition, a force fit is created which in itself is sufficient to hold the crank webs and crank pins operationally reliably, i.e. even during operation of the crankshaft in the internal combustion engine. The modular structure makes it possible to lower costs and increase design flexibility. To achieve for example a different lift height, it is only necessary to select correspondingly adapted crank webs, wherein the crank pins may remain unchanged. Also, different specifications can be fulfilled by providing different crank pins and crank webs. With an assembled crankshaft, the advantage furthermore is achieved that the bearing may be more versatile, wherein in particular closed roller or thrust bearings may also be used which are placed on the crank pins before pressing of the joint partners.

According to the invention, it is proposed that the receiver openings taper at least in portions with a curvature, starting from an insert side facing the assigned crank pin in the direction of an opposite side. Also the fixing portions may additionally taper towards their free ends.

The receiver openings and the fixing portions of the crank pins optionally also have a curved form at least in portions, in order to achieve a particularly even force transmission. In particular, the fixing portions may have a convex curvature while the receiver openings are curved in a complementary fashion on their inside. An embodiment is particularly preferred in which the receiver openings and/or the fixing portions have a parabolic course in a longitudinal section, at least in portions. In combination with the toothing, this ensures that the press-fit takes place over a longer region with increasing material deformation, whereby a loading on the face of the toothing is avoided. Furthermore, a very sudden steep force increase on press fit is also avoided.

Due to the curved, in particular parabolic tapering, at least in portions, of the receiver openings and optionally also of the fixing portions, a substantial improvement is achieved both over the cylindrical and the conical form. With a cylindrical form, the distribution of the forces occurring on joining is not ideal. With a cylindrical design, a very high loading is observed at the face of the normally harder joint partner having the toothing. The material displacement of the softer joint partner takes place substantially on the face of the toothing, whereby there is a risk of overload. In addition, with a cylindrical design of the receiver openings and the fixing portions, the force-fit connection requires improvement.

If the receiver openings and the assigned fixing portions have a complementary conical form, the fixing portions may first be inserted loosely in the assigned receiver openings, wherein a contact between the two joint partners then takes place simultaneously over a longer region. Starting from such a first contact, pressing takes place with a comparatively short stroke, so that very high forces can occur.

Because the toothing formed on the one joint partner can cut or dig into the material of the other joint partner and displace the material of the other joint partner, it is suitable if the joint partner provided with the toothing has a greater hardness in order to achieve a defined connection.

The material combination, the geometry of the receiver openings and the fixing portions of the crank pins, and the pressing force, should be selected such that the force fit connection provided according to the invention is achieved, which securely fixes the joint partners in the longitudinal direction even during operation.

Starting from the tapering according to the invention, to form the toothing, longitudinal grooves may be formed with a distance from a longitudinal axis of the receiver opening which remains constant over their course. Correspondingly, the tapering described leads to the situation that teeth are produced between the longitudinal grooves, the height of which increases from the insert side in the direction of the opposite side. If the flanks of the grooves do not run perpendicular to a base of the groove, the width of the teeth also diminishes accordingly at their tooth tip. Such a configuration means that the teeth must cut into the material of the softer joint partner at first with only a low height, wherein then the material displacement increases evenly as the insert depth increases. This ensures that the cutting forces from joining are distributed over a large area of the teeth or their flanks.

A corresponding increase in height and reduction in width of the teeth also occurs if, according to an alternative embodiment of the invention, the fixing portions are provided with the toothing and taper in the direction of their free ends. At the free ends, no teeth or only low teeth are present, wherein then the height of the teeth increases starting from the free end. The grooves may be produced by a reaming tool guided in the longitudinal direction. By corresponding choice of reaming diameter and the form of the receiver opening or fixing portion, it can be achieved that, starting from the insert side of the receiver opening, a front region is not reamed, producing an insert region with centering effect. Since the toothing follows the unreamed region practically steplessly, any stresses occurring may be reduced.

Due to the material displacement proposed as part of the invention and the contour deformation, an absence of play is also ensured under the operating conditions of the internal combustion engine although the forces and moments occurring change substantially depending on the cycle of the internal combustion engine.

As part of the invention, the concrete embodiment of the toothing is not restricted. To achieve a torque-transmitting form fit, in principle the formation of one groove or one tooth would already be sufficient. Preferably however teeth are arranged distributed evenly about the inner periphery of the receiver opening or the outer periphery of the fixing portion and running in the longitudinal direction.

An embodiment is particularly preferred in which, to form the toothing, grooves running in the longitudinal direction with an arcuate cross section are formed, in order to reduce stress concentrations. In particular where the maximum tooth height is reached, i.e. at the side of the receiver opening opposite the respective crank pin, the width of the tooth may correspond approximately to the radius of the arcuate course of the groove. The teeth are then formed substantially evenly, i.e. they run along the original outer face of the fixing portions or inner face of the receiver opening which is usually circular in cross section.

According to a preferred refinement of the present invention, the receiver openings have an untoothed centering and supporting diameter on the insert side at which the fixing portion of the assigned crank pin is inserted, wherein also the crank pins have a complementary centering and supporting diameter. The mutually assigned supporting diameters have a radial widening compared with the adjacent region of the receiver opening or fixing portion, wherein the mutually assigned centering and supporting diameters may be formed cylindrical or almost cylindrical over at least part of their length. Due to the mutually assigned centering and supporting diameters, after joining, the forces acting on the crank pins can be better absorbed and dissipated without influencing the form-fit connection through the toothing. Due to the centering and supporting diameter mounted before the force application and force transmission of the toothing, the toothing can be protected in the long term from deterioration by deformation. This avoids a reduction in fixing forces between the crank webs and the crank pins due to knocking or wearing out.

The centering and supporting diameters furthermore guarantee that at the end of the joining process, the two parts to be connected together are brought into a precisely defined position and arranged precisely at right angles to each other.

The division of each receiver opening into a front, untoothed region with the supporting diameter and a rear, toothed region may be selected according to the respective requirements. Preferably it is proposed that an untoothed portion of the receiver opening having the supporting diameter extends, starting from the respective insert side, over 15% to 45% of the total length of the receiver opening. In particular, the proportion may lie between 25% and 35%.

The object of the invention is also an assembled crankshaft for an internal combustion engine which can be produced using the method described above. The assembled crankshaft comprises crank webs having receiver openings and crank pins having end fixing portions, wherein the crank webs and crank pins can be connected together by form- and force-fit without further fixing means such as bolts and also without a material fit by welding or similar. According to the invention, the crank webs and crank pins are pressed together as joint partners, wherein the joint partners have a different hardness, wherein the harder joint partner has a pre-produced toothing and wherein the material of the softer joint partner is displaced and deformed in regions by the toothing. Also in the assembled state, according to a particularly preferred embodiment of the invention, it is proposed that the contact face of the mutually assigned joint partners runs parabolically at least along tooth tips of the toothing.

In their general configuration, the crank webs usually have two adjacent receiver openings. Sufficient material thickness must be provided around the receiver openings to ensure adequate stability. Between the two receiver openings however, the crank webs may have a constriction to reduce the rotating mass.

The crank webs may in particular be formed as forgings, wherein in particular 42CrMo4 is suitable as a material. The tapering, preferably parabolically tapering, inner form of the receiver openings may for example be created by boring after the forged crank webs have been blasted and hardened. If the receiver openings are to be fitted with a toothing, the toothing is suitably produced by reaming the grooves in the longitudinal direction of the receiver openings.

On the side facing the crank pins, an annular indentation may be provided around the receiver opening in order to allow a degree of material expansion on joining of the parts. Finally, it is suitable if a hopper-like radius is provided on the insert side starting from the face.

The bearing journals may for example be formed from material 100Cr6. The fixing portions are then preferably provided with a tapering form, in particular a parabolically tapering form. Where a step is provided between the fixing portions and the following portions of the crank pins, preferably a radius is provided starting from the fixing portions in order to guarantee an even force transmission.

To facilitate introduction into the receiver openings, the fixing portions may also be provided with a beading. This means that protrusions and recesses are formed on the fixing portions running in the peripheral direction, so that in the longitudinal section a wave shape results. On connection of the joint partners, then the press force necessary for cutting the toothing may be modulated according to the wave form, wherein due to the parabolic form described and an increase in height of the teeth, the effect of such modulation is reduced by the simultaneous deformation in different length portions.

A parabolic course in the context of the invention means a form which corresponds to the shape of a parabola, when the Y axis of the parabola runs along the longitudinal axis of the receiver opening. In the widest sense, this gives a cup-like design, wherein the receiver opening is however open at both ends so that the course corresponds merely to a portion of a parabolic rotational body. Based on the concept of a truncated cone, the course may be described as a truncated parabola.

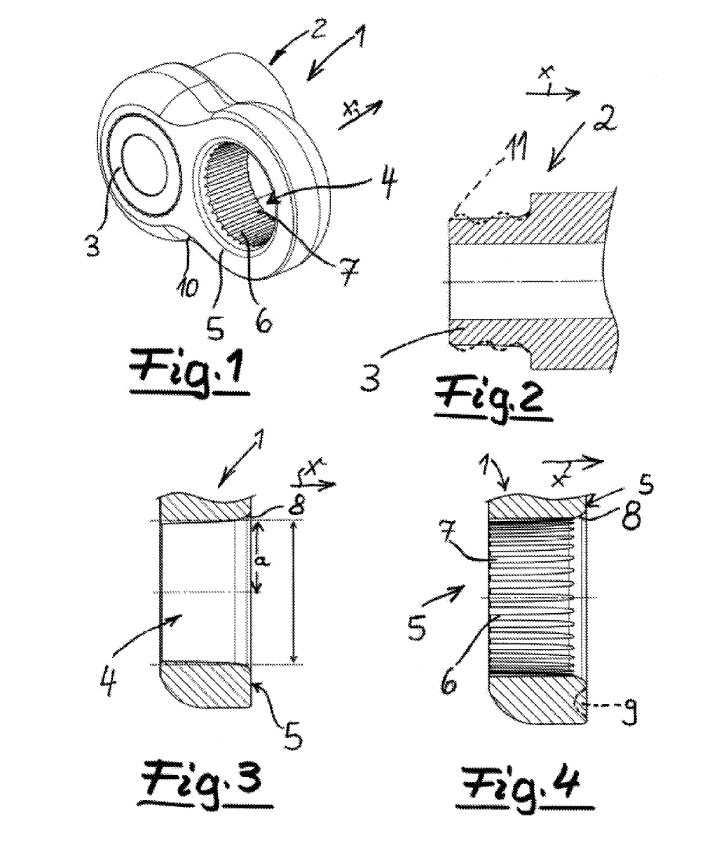

FIG. 1 shows a crank web 1 and a crank pin 2 which is inserted with a fixing portion 3 in a receiver opening 4 of the crank web 1. The crank web 1 comprises a further receiver opening 4 which is provided for receiving a further crank pin 2 from the opposite side. Either connecting rods (not shown) or the crankshaft formed by several crank pins 2 and crank webs 1 can be mounted on the crank pins 2.

Irrespective of whether the insert directions of two crank pins 2 on a crank web 1 are opposite, starting from an insert side 5 of the receiver opening 4 assigned to the respective crank pin 2, the configuration of both receiver openings 4 on a crank web 1 is the same in the exemplary embodiment shown. As shown in FIG. 1, both receiver openings 4 have a toothing running in the longitudinal direction x of the crankshaft, with teeth 6 and grooves 7 running in-between. It is already evident from FIG. 1 that starting from the insert side 5, the teeth 6 first begin at a distance from the edge of the receiver opening 4, wherein the height difference between the tips of the teeth 6 and the base of the grooves 7 increases starting from the insert side 5 into the receiver opening 6. At the same time, the width of the teeth 6 at their tooth tip is less.

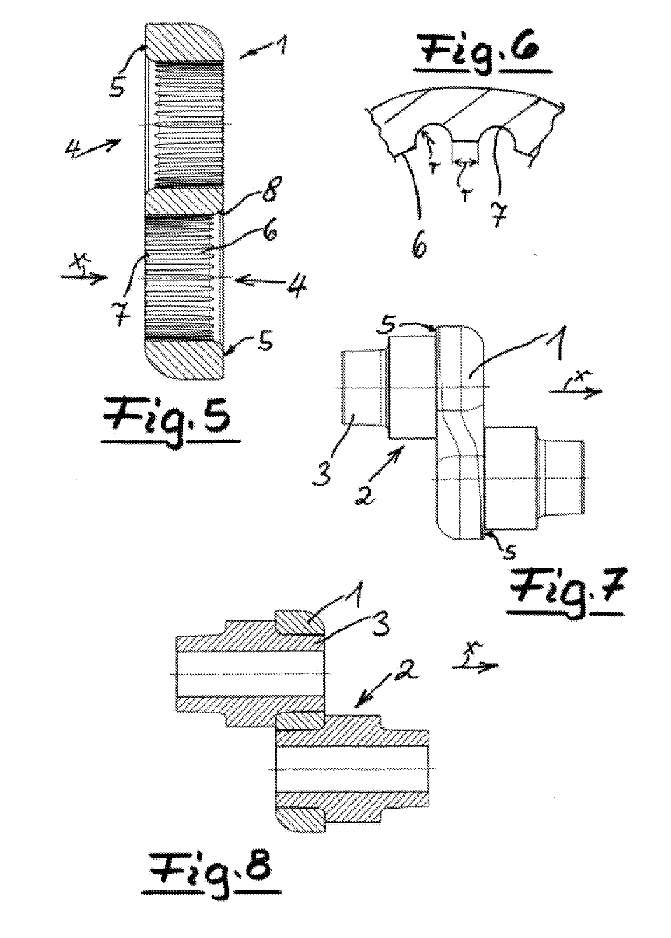

FIG. 3 shows a receiver opening 4 of the crank webs 1 before production of the toothing. It is clear that the receiver openings 4 first have a hopper-like widening 8 with a radius, which firstly has a centering effect when an assigned fixing portion 3 of a crank pin 2 is pressed in. In addition, the hopper-like widening 8 also avoids material stresses immediately at the edge of the receiver opening 4.

In addition, it is also evident that the receiver opening 4 tapers starting from the insert side 5. Particularly preferably, the connecting region runs parabolically from the insert side 5 to the hopper-like widening 8.

FIG. 3 furthermore shows that the grooves 7 of the toothing are produced by a reaming tool guided in the longitudinal direction x. The grooves 7 of the toothing then have a constant distance a along their course from a longitudinal axis of the receiver openings.

As shown in FIG. 4, this leads to the grooves 7 only beginning at a certain distance from the face of the crank webs 1 on the insert side 5, wherein starting from a base of the grooves 7, the height of the teeth 6 increases starting from the insert side 5 and the teeth 6 become narrower at their tip. Because of this form, the crank pin 2 shown in FIG. 2, which is also formed parabolic at its fixing portion 3, on pressing into the receiver opening 4, is evenly deformed on its outer surface, whereby a distributed force transfer and a particularly firm force-fit connection are achieved.

FIG. 4 also indicates that at the insert side 5, a peripheral load-relief notch 9 may be provided around the receiver opening 4 to reduce the stresses in the crank web 1.

It is evident from FIGS. 1 and 2 that according to a preferred embodiment, the entire crank pin 2 is hollow in order to reduce both the weight and the rotating mass. Also the crank webs 1 have indentations 10 between the receiver openings 4 for the same purpose.

Finally, FIG. 2 shows that the fixing portions 3 may optionally also be provided with a beading 11, wherein waves are formed running around the periphery.

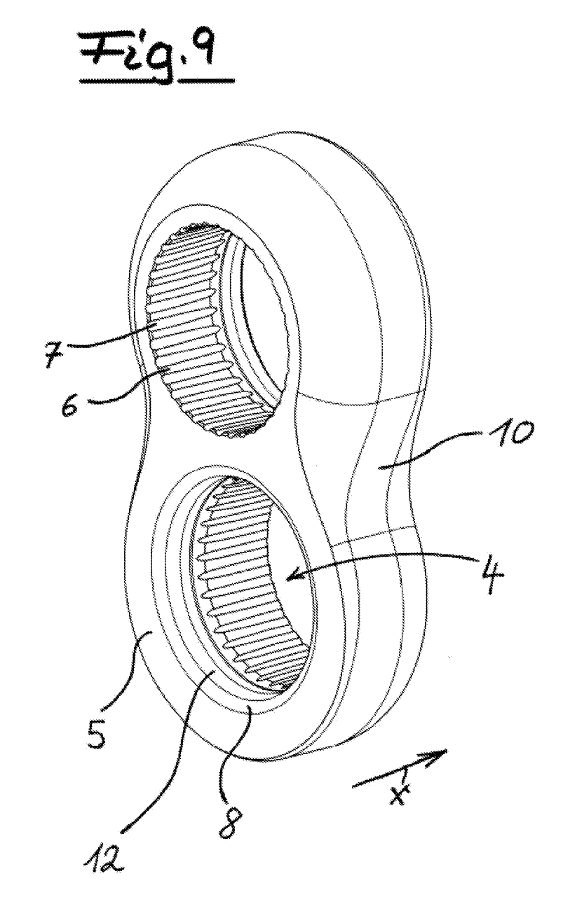

FIG. 5 finally shows a complete crank web which is provided with a toothing at its two receiver openings 4 with opposing insert sides 5. It is directly evident that apart from the opposing arrangement of the insert side 5, the configuration is the same.

FIG. 6 finally shows a preferred embodiment of the toothing, wherein the grooves 7 running in the longitudinal direction have an arcuate cross section with a radius r. FIG. 6 shows the toothing in a region remote from the insert side 5, wherein there the width of the teeth 6 corresponds approximately to the radius r of the grooves 7. The shape of the grooves 7 described effectively reduces the stress concentration.

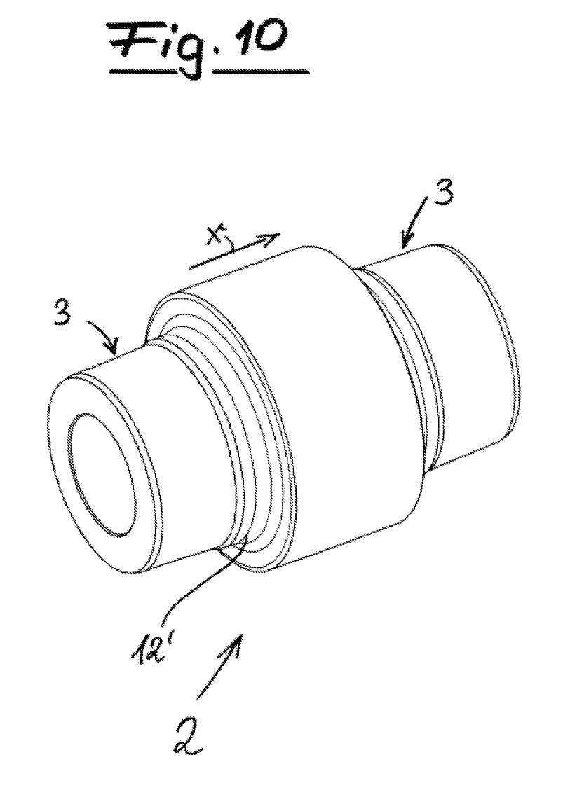

Finally, FIGS. 7 and 8 show a crank web 1 with two crank pins 2 pressed in from opposing sides. The crank pins 2 are held by the toothing and pressing firstly in form fit and secondly in force fit. There is no need for nor any provision of an additional fixing of the crank pins 2 to the crank webs 1 even for operation of the crankshaft. Apart from the fact that further fixing measures are costly, these could also create undesirable imbalances.

Starting from FIG. 8 it is evident that the entire crankshaft is composed of a plurality of crank webs 1 and crank pins 2 joined together, wherein due to the modular structure, there are many variation possibilities.

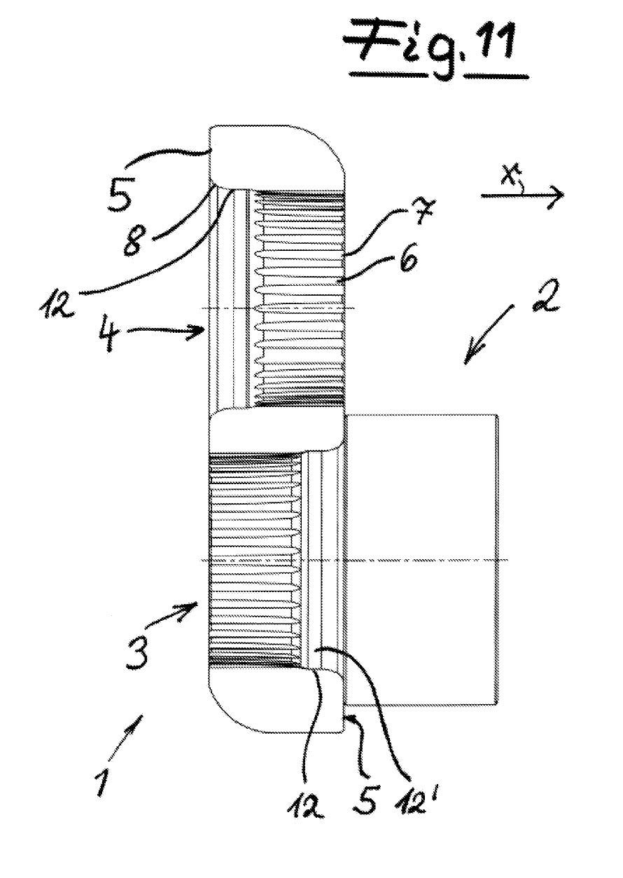

FIG. 9 shows an alternative embodiment of a crank web 1 which on its insert side 5 firstly has the hopper-like widening 8 described above and then a subsequent centering and supporting diameter 12. The hopper-like widening 8 and the centering and supporting diameter 12 are arranged on an untoothed portion of the receiver opening 4 which extends over around 30% of the total length of the receiver opening 4.

It is evident from FIGS. 10 and 11 that the crank pin 2 is provided with an assigned centering and supporting diameter 12′.

The centering and supporting diameters 12, 12′ guarantee firstly, on pressing, a precise centering and alignment of the crank pin 2 relative to the crank web 1. Furthermore, after assembly, the entire assembled crankshaft also has advantages because the forces acting on the crank pins 2 may be transmitted to the adjacent crank webs 1 via the mutually assigned centering and supporting diameters 12, 12′ without the toothing formed by the grooves 7 and the teeth 6 being overloaded.

1-9. (canceled)

10. A method for producing an assembled crankshaft for an internal combustion engine, the method comprising:
providing crank webs with receiver openings and (ii) crank pins with fixing portions at their ends, the crank webs and crank pins are provided as joint partners wherein the crank webs are provided with receiver openings which taper in the longitudinal section at least in portions in a parabolic shape, starting from an insert side facing the assigned crank pin in the direction of an opposite side;
providing one of the receiver openings or the fixing portions with a toothing running in a longitudinal direction (x) of the crankshaft, wherein the cross section of the fixing portions extends in regions through the toothing beyond an inner cross section of an assigned receiver opening; and
connecting the joint partners wherein a material displacement and contour deformation occurs at one of the receiver openings of the crank webs or at the fixing portions of the crank pins, and the joint partners are thus connected by form fit.

11. The method of claim 10 wherein the connecting further comprises:
pressing the fixing portions into the receiver openings such that the joint partners are fixed together operationally reliably in a force fit connection without further fixing means and without an additional connection in the longitudinal direction (x).

12. The method of claim 11, further comprising:
forming the toothing, wherein grooves are formed with a distance from a longitudinal axis of the receiver opening which remains constant over their course, so that teeth are produced between the grooves, the height of which increases from the insert side in the direction of the opposite side.

13. The method of claim 12, further comprising:
producing the grooves by a reaming tool guided in the longitudinal direction (x).

14. The method of claim 10 wherein the fixing portions taper towards their free ends.

15. The method of claim 12 wherein forming the toothing further comprises:
forming grooves running in the longitudinal direction with an arcuate cross section.

16. An assembled crankshaft for an internal combustion engine comprising:
a crank web having receiver openings;
crank pins having end fixing portions that are connected together to the crank webs by form- and force-fit without further fixing means; and
wherein the crank web and crank pins are pressed together as joint partners and have a different hardness, wherein the harder joint partner has a pre-produced toothing, wherein the material of the softer joint partner is displaced and deformed in regions by the toothing, and wherein a contact face between the joint partners runs parabolically at least along tooth tips of the toothing.

17. The assembled crankshaft of claim 16 wherein the crank web is formed as forging.

18. The assembled crankshaft of claim 16 wherein the receiver openings have an untoothed centering and supporting diameter on an insert side at which the fixing portion of the assigned crank pin is inserted.

19. The assembled crankshaft of claim 18 wherein the crank pins have a complementary centering and supporting diameter.

20. The assembled crankshaft of claim 18 wherein the crank web further defines a hopper-like widening proximate the untoothed centering and supporting diameter.

21. The assembled crankshaft of claim 18 wherein the untoothed portion of the receiver openings having the centering and supporting diameter extends, starting from the respective insert side, over 15% to 45% of a total length of the receiver openings.

22. The assembled crankshaft of claim 18 wherein teeth of the toothing having a height that increases starting from the insert side.

23. The assembled crankshaft of claim 22 wherein the teeth become narrower toward respective tips thereof.

24. The assembled crankshaft of claim 23 wherein the crank web defines a peripheral load-relief notch around at least one of the receiver openings.
